(19) United States
(12) Patent Application Publication
(10) Pub. No.: US 2019/0087208 A1
(43) Pub. Date: Mar. 21, 2019

(54) METHOD AND APPARATUS FOR LOADING ELF FILE OF LINUX SYSTEM IN WINDOWS SYSTEM

(71) Applicant: BEIJING QIHOO TECHNOLOGY COMPANY LIMITED, Beijing (CN)

(72) Inventors: Han YAN, Beijing (CN); Xin RAN, Beijing (CN); Zhihui LIANG, Beijing (CN)

(21) Appl. No.: 15/741,163

(22) PCT Filed: Oct. 31, 2016
(86) PCT No.: PCT/CN2016/104061

§ 371 Date: Dec. 29, 2017

(30) Foreign Application Priority Data
Aug. 31, 2016 (CN) 201610799064.1

(51) Int. Cl. G06F 9/445; G06F 12/1009; G06F 16/903; G06F 16/901

(52) U.S. Cl. CPC G06F 9/44557; G06F 9/44521; G06F 16/901; G06F 16/903; G06F 12/1009

(57) ABSTRACT

The present invention discloses a method and apparatus for loading an ELF file of a Linux system into a Windows system. The method comprises: resolving the ELF file in accordance with a format of the ELF file; loading the whole ELF file into a Windows system memory according to a Windows system memory storage rule; acquiring a memory address, of a file content corresponding to a symbol recorded in a symbol table of the ELF file, in the Windows system in accordance with a resolution result of the ELF file; and linking the symbol with the memory address, of the file content corresponding to the symbol, in the Windows system.

### FIELD OF TECHNOLOGY

The present invention relates to the field of computer software technologies, and specifically to a method and apparatus for loading an Executable and Linking Format (ELF) file of a Linux system into a Windows system, a computer program and a computer-readable medium.

### BACKGROUND

With popularization of mobile terminals installed with Android operating systems, more and more Android applications applied to the mobile terminals installed with Android operating systems thereupon appear on the application market. These Android applications greatly meet users' demands for life, entertainment and shopping, etc. However, due to limitations of mobility characteristics such as portability, the mobile terminals have problems of smaller screens, heat-prone processors, poor battery endurance ability and unstable network signal or the like, which may cause poor user visual experience and may cause interrupted or sluggish operation when in use. For this reason, a user may solve the above problems by running Android applications using a personal computer (PC) installed with a Windows system.

It may be implemented that the Android applications run on the PC installed with the Windows system by installing an Android virtual machine on the PC installed with the Windows system and by virtually running the Android operating system in the Android virtual machine, so that the user may have a better visual experience on a larger display screen and improve a running speed. However, because running of the Android virtual machine needs to consume a lot of hard-disk space and memory of the run, to a certain extent, this manner may affect a speed of running the Android applications on the PC.

The Android applications include many ELF files of a Linux system. The speed of running the Android applications on the PC may be greatly improved when these files are directly loaded onto the Windows system for running, thereby solving the problems of slow or sluggish running of the Android applications on the PC. However, the prior art has not provided a method and apparatus for loading an ELF file of a Linux system into a Windows system yet.

### SUMMARY

In view of the aforementioned problems, the present invention is proposed to provide a method and apparatus for loading an ELF file of a Linux system into a Windows system for overcoming the aforementioned problems or at least in part solving the aforementioned problems.

According to an aspect of the present invention, there is provided a method for loading an ELF file of a Linux system into a Windows system, which comprises: resolving the ELF file in accordance with a format of the ELF file; loading the whole ELF file into a Windows system memory according to a Windows system memory storage rule; acquiring a memory address, of a file content corresponding to a symbol recorded in a symbol table of the ELF file, in the Windows system in accordance with a resolution result of the ELF file; and linking the symbol with the memory address, of the file content corresponding to the symbol, in the Windows system.

According to another aspect of the present invention, there is provided an apparatus for loading an ELF file of a Linux system into a Windows system, which comprises: a resolving module, configured to resolve the ELF file in accordance with a format of the ELF file; a loading module, configured to load the whole ELF file into a Windows system memory according to a Windows system memory storage rule; an acquiring module, configured to acquire a memory address, of a file content corresponding to a symbol recorded in a symbol table of the ELF file, in the Windows system in accordance with a resolution result of the ELF file; and a linking module, configured to link the symbol with the memory address, of the file content corresponding to the symbol, in the Windows system.

By using the method and apparatus for loading an ELF file of a Linux system into a Windows system according to the present invention, after the ELF file is resolved, the whole ELF file is loaded into a Windows system memory according to a Windows system memory storage rule. A memory address, of a file content corresponding to a symbol recorded in a symbol table of the ELF file, in the Windows system is acquired in accordance with a resolution result of the ELF file. The symbol is linked with the memory address, of the file content corresponding to the symbol, in the Windows system. In this way, it is implemented that the ELF file may be directly loaded into the Windows system memory so that a symbol, such as a function and so on, in the ELF file may directly run on the Windows system without installing an Android virtual machine on the Windows system. Meanwhile running speed is greatly lifted, and occupation of hard disk space and a memory is reduced.

Described above is merely an overview of a technical solution of the present invention. In order to more apparently understand the technical means of the present invention to implement in accordance with the contents of specification, and to more readily understand above and other objectives, features and advantages of the present invention, specific embodiments of the present invention are provided hereinafter.

### BRIEF DESCRIPTION OF THE DRAWINGS

Through reading the detailed description of the following preferred embodiments, various other advantages and benefits will become apparent to an ordinary person skilled in the art. Accompanying drawings are merely included for the purpose of illustrating the preferred embodiments and should not be considered as limiting of the invention. Further, throughout the drawings, same elements are indicated by same reference numbers. In the drawings:

FIG. 1 is a flowchart of a method for loading an ELF file of a Linux system into a Windows system according to an embodiment of the present invention;

FIG. 2 is a flowchart of a method for loading an ELF file of a Linux system into a Windows system according to another embodiment of the present invention;

FIG. 3 is a functional block diagram of an apparatus for loading an ELF file of a Linux system into a Windows system according to an embodiment of the present invention;

FIG. 4 is a functional block diagram of an apparatus for loading an ELF file of a Linux system into a Windows system according to another embodiment of the present invention;

FIG. 5 is a block diagram of a computing device for executing the method for loading an ELF file of a Linux system into a Windows system according to the present invention; and

FIG. 6 is a memory cell for maintaining or carrying a program code for implementing the method for loading an ELF file of a Linux system into a Windows system according to the present invention.

### DESCRIPTION OF THE EMBODIMENTS

Exemplary embodiments of the present invention will be described in detail with reference to the accompanying figures hereinafter. Although the exemplary embodiments of the present invention are illustrated in the accompanying figures, it should be understood that the present invention may be embodied in many different forms and should not be construed as being limited to the embodiments set forth herein. Rather, these embodiments are provided so that this present invention will be understood thoroughly and completely and will fully convey the scope of the present invention to those skilled in the art.

As a common object file format in a Linux system, an ELF file is classified into three file types, namely a relocatable object file, an executable object file and a shareable object file (namely, a dynamic link library file). In the embodiments of this application, mainly loading of the executable object file and the shareable object file is described. The ELF file includes an ELF header, a program header table, a section header table, sections or segments, etc. The ELF header describes an organization structure of the whole ELF file, for example, an entry address, an offset address, a size, a structure, a section or a segment and so on of the program header. The program header table points out how to create a process image, and a section header table includes information such as an entry, a give name and a size or the like of each section. The section provides various information of the object file, for example, an instruction, data, a symbol table and relocation information, etc. The symbol table includes information for locating and relocating symbol definitions and references in a program. It may be simply understood that the symbol table records all symbols in the file. The so-called symbols refer to modified function names or variable names. All the above involved contents need to be loaded into the Windows system.

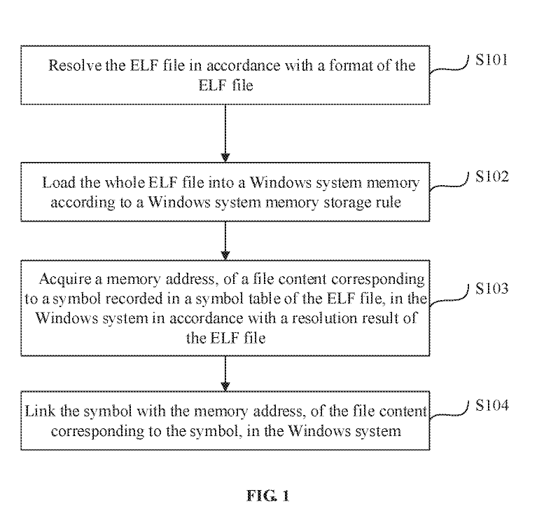

FIG. 1 is a flowchart of a method for loading an ELF file of a Linux system into a Windows system according to an embodiment of the present invention. As shown in FIG. 1, the method for loading an ELF file of a Linux system into a Windows system specifically includes following steps.

Step S101: resolving the ELF file in accordance with a format of the ELF file.

When resolving the ELF file, contents of the ELF header of the ELF file need to be resolved. The contents of the ELF header include information such as a type of the ELF file, a system architecture required for running the ELF file, a version of the ELF file, a starting address of the ELF file, the offset address of the program header table in the ELF file, the offset address of the section header table in the ELF file, the size of the ELF header, the size of an entry in the program header table (all the entries have the same size), the number of the entries in the program header table, the size of a section header, and the number of the entries of the section header, etc. These contents need to be used when calculating an address in subsequent steps.

Step S102: loading the whole ELF file into a Windows system memory according to a Windows system memory storage rule.

The Windows system and the Linux system have their respective storage rules. The ELF file is a file of a Linux system format. To load the ELF file into the Windows system memory, alignment and/or across-page processing need to be conducted according to the Windows system memory storage rule.

According to a Windows system memory alignment rule, the alignment processing is conducted when it is impossible to continue storing the ELF file due to insufficient current byte space in the Windows system memory. When conducting the alignment processing, bytes of remaining ELF files are stored according to a manner in which free space of the Windows system memory is allocated from a high address to a low address. When the ELF file is loaded according to the Windows system memory storage rule, since the ELF file itself is a Linux system file, its storage mode is different from a Windows system storage mode. For example, a byte length occupied by a Linux system variable is different from that occupied by a Windows system variable, which may cause a problem that, when in storage, certain space may be left after one or more bytes in the ELF file are stored in bytes of the Windows system because one-to-one or one-to-more storage may be not exactly implemented for the bytes of the Windows system and the bytes in the ELF file and the space left is insufficient to continue storing one byte in the ELF file. For example, when the bytes of the Windows system still have a memory space of 16k but three 6k bytes in the ELF file need to be stored, the bytes of the Windows system may only store two 6k bytes in the ELF file, that is, the remaining 6k byte in the ELF file needs to be stored in another byte of the Windows system. When aligning, the address of the latter byte of the Windows system needs to be recorded so that it is convenient to rapidly search out the whole ELF file stored in the Windows system with different bytes.

The Windows system memory is managed by page. Contents of an equal byte length are stored on each page. Since the ELF file itself is a Linux file, its storage mode is different from a Windows system storage mode. For example, a byte length occupied by a Linux system variable is different from that occupied by a Windows system variable, which may cause a problem that, when in storage, it is impossible to continue storing the remaining ELF files due to insufficient current page space in the Windows system memory. In this case, cross-page processing needs to be performed, after which, the remaining ELF files may be continued to be stored in new page space. During the cross-page processing, the address of the new page space after cross-page needs to be recorded so that it is convenient to find the whole ELF file stored by searching out the address of the new page after cross-page from the current page.

Step S103: acquiring a memory address, of a file content corresponding to a symbol recorded in a symbol table of the ELF file, in the Windows system in accordance with a resolution result of the ELF file.

The symbol recorded in the symbol table includes function names and/or global variable names used in the ELF file. File contents corresponding to these function names are function bodies, and file contents corresponding to the global variable names are global variables.

The starting address of the ELF file and a plurality of offset addresses of the file content may be obtained after the content of the ELF header of the ELF file is resolved In Step S101. Address information of the function body in the ELF file may be obtained according to the file starting address and offset addresses. For example, when the starting address of the ELF file is 10 and the offset address of a certain Function A is 200, it may be obtained that the address information of the function body of the Function A is 210. The address information 210 is the address, in the ELF file, of the function body of the Function A. In Step S102, after the whole ELF file is loaded into the Windows system memory, it is also needed to acquire a memory address corresponding to the function body of the Function A in the corresponding Windows system.

The acquiring a memory address corresponding to the function body of the Function A in the Windows system includes: recording an actual starting address of the ELF file in the Windows system memory when loading the whole ELF file into the Windows system; and calculating the memory address actually corresponding to the function body of the Function A according to the actual starting address, the offset address of the Function A, the Windows system memory alignment rule and a cross-page rule.

Step S104: linking the symbol with the memory address, of the file content corresponding to the symbol, in the Windows system.

After Step S103 is executed, the symbol is linked with the acquired memory address, of the file content corresponding to the symbol, in the Windows system so that the file content corresponding to the symbol may be executed according to the link when the symbol is invoked or used.

By using the method for loading an ELF file of a Linux system into a Windows system according to an embodiment of the present invention, after the ELF file is resolved, the whole ELF file is loaded into the Windows system memory according to a Windows system memory storage rule. A memory address, of a file content corresponding to a symbol recorded in a symbol table of the ELF file, in the Windows system is acquired in accordance with a resolution result of the ELF file. The symbol is linked with the memory address, of the file content corresponding to the symbol, in the Windows system. In this way, it is implemented that the ELF file is directly loaded into the Windows system memory so that a symbol, such as a function and so on, in the ELF file may directly run on the Windows system without installing the Android virtual machine on the Windows system. Meanwhile running speed is greatly lifted, and occupation of hard disk space and a memory is reduced.

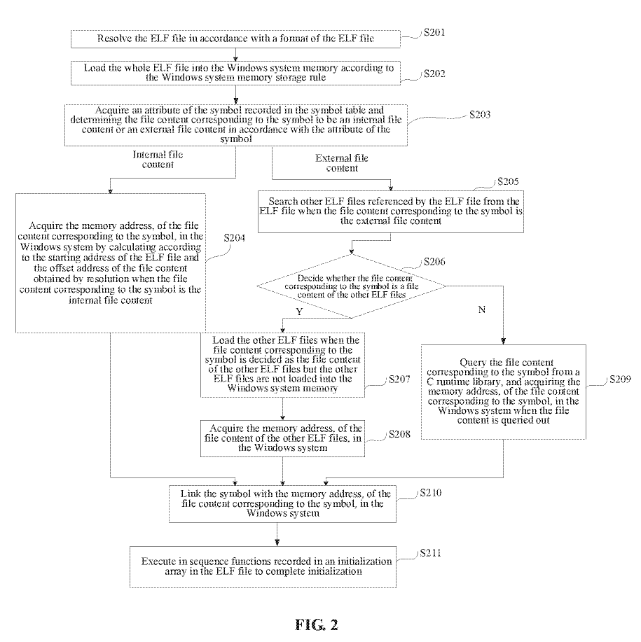

FIG. 2 is a flowchart of a method for loading an ELF file of a Linux system into a Windows system according to another embodiment of the present invention. As shown in FIG. 2, the method for loading an ELF file of a Linux system into a Windows system specifically includes following steps.

Step S201: resolving the ELF file in accordance with a format of the ELF file.

Step S202: loading the whole ELF file into the Windows system memory according to the Windows system memory storage rule.

Reference may be made to description of Steps S101-S102 in the method embodiments in FIG. 1 for the above steps, which are not unnecessarily described herein.

Step S203: acquiring an attribute of the symbol recorded in the symbol table and determining the file content corresponding to the symbol to be an internal file content or an external file content in accordance with the attribute of the symbol.

The symbol recorded in the symbol table includes function names and/or global variable names used in the ELF file. Some functions are functions implemented by the ELF file itself, and the function body may be found from the ELF file, that is, the file content corresponding to the symbol is the internal file content. Some functions are functions referenced from other ELF files, for example, Function B. The ELF file where the Function B is is invoked by means of #include, so that invoking the Function B is implemented. The function body of the Function B is not in the ELF file, that is, the file content corresponding to the symbol is the internal file content. Still some functions belong to system functions, these functions are neither in the ELF file nor in other ELF files. At present, the function bodies of these functions are arranged in a C runtime library in this application. File contents corresponding to these functions also are external file contents.

It may be known from the attribute of a symbol whether the file content corresponding to the symbol is an internal file content or an external file content. The attribute of a symbol may define that, for example, a function is an undefined reference. That is, the file content corresponding to the symbol is the external file content. Step S204 is executed when the file content corresponding to the symbol is the internal file content. Step S205 is executed when the file content corresponding to the symbol is the external file content.

Step S204: acquiring the memory address, of the file content corresponding to the symbol, in the Windows system by calculating according to the starting address of the ELF file and the offset address of the file content obtained by resolution when the file content corresponding to the symbol is the internal file content.

When the file content corresponding to the symbol is the internal file content, the starting address of the ELF file and a plurality of offset addresses of the file content are obtained by resolving the content of the ELF header of the ELF file. An actual starting address of the ELF file in the Windows system memory is recorded when the whole ELF file is loaded into the Windows system. The memory address actually corresponding to the internal file content is acquired according to the Windows system memory alignment rule and the cross-page rule.

Step S205: searching other ELF files referenced by the ELF file from the ELF file when the file content corresponding to the symbol is the external file content.

Other ELF files referenced by the ELF file need to be searched from the ELF file when the file content corresponding to the symbol is the external file content. There may be many methods for referencing the other ELF files from the ELF file, for example, #include<other ELF files>, file names after #include, namely the other ELF files referenced. Or a dlopen ( ) method and parameters of dlopen are invoked from the ELF file, namely the other ELF files referenced, etc. The other ELF files referenced by the ELF file may be found by means of these reference methods.

Step S206: deciding whether the file content corresponding to the symbol is a file content of the other ELF files.

The file content corresponding to the symbol may be a file content of the other ELF files or may be, for example, a system function. It is required to search, from the other ELF files, whether the file content corresponding to the symbol is present, and then it is decided whether the file content corresponding to the symbol is the file content of the other ELF files.

Step S207 is executed when the file content corresponding to the symbol is searched out from the other ELF files. Otherwise, Step S209 is executed.

Step S207: loading the other ELF files when the file content corresponding to the symbol is decided as the file content of the other ELF files but the other ELF files are not loaded into the Windows system memory.

When the ELF file is loaded into the Windows system memory in Step S202, names of loaded ELF files may be recorded and stored in a list of loaded ELF files. When it is decided that the file content corresponding to the symbol is the file content of the other ELF files, the other ELF files are searched from the list of loaded ELF files. The other ELF files are loaded first when they are not searched out, namely when the other ELF files are not loaded into the Windows system memory. Step S208 is executed after loading the other ELF files. The step of loading the other ELF files is the same as that of loading the ELF file.

Step S208: acquiring the memory address, of the file content of the other ELF files, in the Windows system.

When loading the other ELF files, the step the same as loading the ELF file is executed, the starting addresses of the other ELF files and a plurality of offset addresses of the file content are obtained by resolving the contents of the ELF headers of the other ELF files. The actual starting addresses of the other ELF files in the Windows system memory are recorded when the other ELF files are loaded into the Windows system. The memory addresses of the file contents of the other ELF files in the Windows system are acquired according to the Windows system memory alignment rule and the cross-page rule, and the symbol is linked with the memory address, of the file content corresponding to the symbol, in the Windows system. Since the other ELF files have been loaded, the memory addresses of the file contents of the other ELF files in the Windows system may be directly acquired.

Herein it is to be noted that when the other ELF files have been loaded, Step S208 may be directly executed instead of executing Step S207 of loading the other ELF files.

Step S209: querying the file content corresponding to the symbol from a C runtime library, and acquiring the memory address, of the file content corresponding to the symbol, in the Windows system when the file content is queried out.

The file content corresponding to the symbol is queried from the C runtime library when the file content corresponding to the symbol is not searched out from the other ELF files. The C runtime library includes a reconstruction function of a Linux system function in the Windows system, a reconstruction function of an Android system function in the Windows system, a conversion function for a binary executable file converted to be a Windows system executable file, a thread processing function and/or a signal processing function, etc. For example, libc.so, libandriod.so, libopengles.so, libegl.so, libopensl.so and so on.

The memory address, of the file content corresponding to the symbol, in the Windows system is acquired after the file content corresponding to the symbol is queried out from the C runtime library. The acquiring method is the same as the method for acquiring the memory address, of the file content of the other ELF files, in the Windows system.

Step S210: linking the symbol with the memory address, of the file content corresponding to the symbol, in the Windows system.

After the memory address, of the file content corresponding to the symbol, in the Windows system is acquired in the above step, the symbol is linked with the acquired memory address, of the file content corresponding to the symbol, in the Windows system so that the file content corresponding to the symbol may be executed according to the link when the symbol is invoked or used.

Step S211: executing in sequence functions recorded in an initialization array in the ELF file to complete initialization.

The ELF file whose the ELF file type is an executable object file also needs to be initialized. During the initialization, the functions recorded in the initialization array (Init and/or PreInit) in the ELF file are executed in sequence. The Init is an initialization function that is necessarily executed, and the PreInit is an initialization function that is optionally executed.

By using the method for loading an ELF file of a Linux system into a Windows system according to an embodiment of the present invention, after the ELF file is resolved, the whole ELF file is loaded into the Windows system memory according to a Windows system memory storage rule. The file content corresponding to the symbol is determined to be an internal file content or an external file content in accordance with the attribute of the symbol. The internal file content and the external file content are respectively processed. The memory address, of the file content corresponding to the symbol, in the Windows system is acquired. The symbol is linked with the memory address, of the file content corresponding to the symbol, in the Windows system. The functions recorded in the initialization array in the ELF file are executed in sequence to complete the initialization. Loading the file content corresponding to the symbol and acquiring and linking the symbol with the memory address in the Windows system are implemented when the ELF files are referenced. Meanwhile, the C runtime library is added to reconstruct a plurality of system functions, and a thread processing function and a signal processing function are added, thereby ensuring proper running of the ELF file on the Windows system without installing the Android virtual machine on the Windows system. Meanwhile running speed is greatly lifted, and occupation of hard disk space and a memory is reduced.

FIG. 3 is a functional block diagram of an apparatus for loading an ELF file of a Linux system into a Windows system according to an embodiment of the present invention. As shown in FIG. 3, the apparatus for loading an ELF file of a Linux system into a Windows system specifically includes following modules.

A resolving module 310, configured to resolve the ELF file in accordance with a format of the ELF file.

When resolving the ELF file, the resolving module 310 needs to resolve contents of the ELF header of the ELF file. The contents of the ELF header include information such as a type of the ELF file, a system architecture required for running the ELF file, a version of the ELF file, a starting address of the ELF file, the offset address of the program header table in the ELF file, the offset address of the section header table in the ELF file, the size of the ELF header, the size of an entry in the program header table (all the entries have a same size), the number of the entries in the program header table, the size of a section header, and the number of the entries of the section header, etc. These contents need to be used when calculating an address in subsequent steps.

A loading module 320, configured to load the whole ELF file into a Windows system memory according to a Windows system memory storage rule.

The Windows system and the Linux system have their respective storage rules. The ELF file is a file of a Linux system format. To load the ELF file into the Windows system memory, the loading module 320 needs to conduct alignment and/or across-page processing according to the Windows system memory storage rule.

The loading module 320 loads the ELF file according to the Windows system memory alignment rule. The loading module 320 conducts alignment processing when it is impossible to continue storing the ELF file due to insufficient current byte space in the Windows system memory. When conducting the alignment processing, bytes of remaining ELF files are stored according to a manner in which free space of the Windows system memory is allocated from a high address to a low address. When the loading module 320 loads the ELF file according to the Windows system memory storage rule, since the ELF file itself is a Linux system file, its storage mode is different from a Windows system storage mode. For example, a byte length occupied by a Linux system variable is different from that occupied by a Windows system variable, which may cause a problem that, when in storage, certain space may be left after one or more bytes in the ELF file are stored in bytes of the Windows system because one-to-one or one-to-more storage may be not exactly implemented for the bytes of the Windows system and the bytes in the ELF file and the space left is insufficient to continue storing one byte in the ELF file. For example, when the bytes of the Windows system still have a memory space of 16k but three 6k bytes in the ELF file need to be stored, when the loading module 320 loads the ELF file, the bytes of the Windows system may only store two 6k bytes in the ELF file, that is, the remaining 6k byte in the ELF file needs to be stored in another byte of the Windows system. When aligning, the loading module 320 also needs to record the address of the latter byte of the Windows system so that it is convenient to rapidly search out the whole ELF file stored in the Windows system with different bytes.

The Windows system memory is managed by page. Contents of an equal byte length are stored on each page. Since the ELF file itself is a Linux file, its storage mode is different from a Windows system storage mode. For example, a byte length occupied by a Linux system variable is different from that occupied by a Windows system variable, which may cause a problem that, when the loading module 320 loads the ELF file, it is impossible to continue storing the remaining ELF files due to insufficient current page space in the Windows system memory. In this case, the loading module 320 needs to perform cross-page processing, after which, the remaining ELF files may be continued to be stored in new page space. When performing cross-page processing, the loading module 320 also needs to record the address of the new page space after cross-page so that it is convenient to find the whole ELF file stored by searching out the address of the new page after cross-page from the current page.

An acquiring module 330, configured to acquire a memory address, of a file content corresponding to a symbol recorded in a symbol table of the ELF file, in the Windows system in accordance with a resolution result of the ELF file.

The symbol recorded in the symbol table includes function names and/or global variable names used in the ELF file. File contents corresponding to these function names are function bodies, and file contents corresponding to the global variable names are global variables.

The starting address of the ELF file and a plurality of offset addresses of the file content may be obtained after the resolving module 310 resolves the content of the ELF header of the ELF file. The acquiring module 330 may acquire address information of the function body in the ELF file according to the file starting address and offset addresses. For example, when the starting address of the ELF file is 10 and the offset address of a certain Function A is 200, it may be obtained that the address information of the function body of the Function A is 210. The address information 210 is the address, in the ELF file, of the function body of the Function A. After the loading module 320 loads the whole ELF file into the Windows system memory, the acquiring module 330 also needs to acquire a memory address corresponding to the function body of the Function A in the corresponding Windows system.

The acquiring, by the acquiring module 330, a memory address corresponding to the function body of the Function A in the Windows system includes: recording an actual starting address of the ELF file in the Windows system memory when the loading module 320 loads the whole ELF file into the Windows system. The acquiring module 330 acquires a memory address actually corresponding to the function body of the Function A according to the actual starting address, the offset address of the Function A, the Windows system memory alignment rule and the cross-page rule.

Further, the acquiring module 330 also includes an attribute determining module 331. The attribute determining module 331 is configured to acquire an attribute of the symbol recorded in the symbol table and determine the file content corresponding to the symbol to be an internal file content or an external file content in accordance with the attribute of the symbol.

The symbol recorded in the symbol table includes function names and/or global variable names used in the ELF file. Some functions are functions implemented by the ELF file itself, and the function body may be found from the ELF file, that is, the file content corresponding to the symbol is an internal file content. Some functions are functions referenced from other ELF files, for example, Function B. The ELF file where the Function B is is invoked by means of #include, so that invoking the Function B is implemented. The function body of the Function B is not in the ELF file, that is, the file content corresponding to the symbol is an internal file content. Still some functions belong to system functions, these functions are neither in the ELF file nor in other ELF files. At present, the function bodies of these functions are arranged in a C runtime library in this application. File contents corresponding to these functions also are external file contents.

The attribute determining module 331 may determine, according to the attribute of the symbol whether the file content corresponding to the symbol is the internal file content or the external file content. After acquiring the attribute of the symbol, the attribute determining module 331 may determine that, for example, a function is an undefined reference according to the attribute of the symbol. That is, the file content corresponding to the symbol is the external file content.

According to different file contents corresponding to symbols, different modules are respectively executed to acquire the memory addresses, of the file contents corresponding to the symbols, in the Windows system. An internal file address acquiring module 332 is executed when the file content corresponding to the symbol is the internal file content. An external file searching module 333 is executed when the file content corresponding to the symbol is the external file content.

The internal file address acquiring module 332 is configured to acquire the memory address actually corresponding to the internal file content according to the Windows system memory alignment rule and the cross-page rule when the file content corresponding to the symbol is the internal file content, according to the starting address of the ELF file and a plurality of offset addresses of the file content obtained by resolving the content of the ELF header of the ELF file by the resolving module 310, and according to the actual starting address of the recorded ELF file in the Windows system memory when the loading module 320 loads the whole ELF file into the Windows system.

The external file searching module 333 is configured to search other ELF files referenced by the ELF file from the ELF file when the file content corresponding to the symbol is the external file content.

The external file searching module 333 searches other ELF files referenced by the ELF file from the ELF file when the file content corresponding to the symbol is the external file content. There may be many methods for referencing other ELF files from the ELF file, for example, #include<other ELF files>, file names after #include, namely other ELF files referenced. Or a dlopen ( ) method and parameters of dlopen are invoked from the ELF file, namely other ELF files referenced, etc. The external file searching module 333 may find out other ELF files referenced by the ELF file by searching these reference methods.

A deciding module 334 is executed after the external file searching module 333 finds out other ELF files referenced by the ELF file.

The deciding module 334 is configured to decide whether the file content corresponding to the symbol is a file content of the other ELF files. The file content corresponding to the symbol may be a file content of the other ELF files or may be, for example, a system function. By searching, from the other ELF files, whether the file content corresponding to the symbol is present, the deciding module 334 decides whether the file content corresponding to the symbol is the file content of the other ELF files. An external file address acquiring module 335 is executed when the deciding module 334 searches out, from the other ELF files, the file content corresponding to the symbol, namely, the file content corresponding to the symbol is the file content of the other ELF files. Otherwise, a C runtime library address acquiring module 336 is executed.

The external file address acquiring module 335 is configured to acquire the memory address, of the file content of the other ELF files, in the Windows system.

In addition, an external file deciding and loading module 350 needs to be executed before the external file address acquiring module 335 acquires the memory address, of the file content of the other ELF files, in the Windows system. The external file deciding and loading module 350 is configured to further decide whether the other ELF files have been loaded into the Windows system memory when the file content corresponding to the symbol is decided as the file content of the other ELF files, and load the other ELF files when they are not loaded yet.

When the loading module 320 is executed to load the ELF files into the Windows system memory, the loading module 320 may also record names of loaded ELF files and store them in a list of loaded ELF files. When the deciding module 334 decides that the file content corresponding to the symbol is the file content of the other ELF files, the external file deciding and loading module 350 searches the other ELF files from the list of loaded ELF files. The other ELF files are loaded first when they are not searched out, namely when the other ELF files are not loaded into the Windows system memory. After loading the other ELF files, the external file address acquiring module 335 is executed again.

When loading the other ELF files, also the loading is completed by executing the resolving module 310, the loading module 320, the acquiring module 330 and the linking module 340. The external file address acquiring module 335 may directly acquire, from the other ELF files loaded, the memory address, of the file content of the other ELF files, in the Windows system.

A C runtime library address acquiring module 336 is configured to query the file content corresponding to the symbol from a C runtime library when the file content corresponding to the symbol is the external file content, and acquire the memory address, of the file content corresponding to the symbol, in the Windows system when the file content is queried out.

When the deciding module 334 decides that no file content corresponding to the symbol is searched out from the other ELF files, the C runtime library address acquiring module 336 is executed to query the file content corresponding to the symbol from the C runtime library. The C runtime library includes a reconstruction function of a Linux system function in the Windows system, a reconstruction function of an Android system function in the Windows system, a conversion function for a binary executable file converted to be a Windows system executable file, a thread processing function and/or a signal processing function, etc. For example, libc.so, libandriod.so, libopengles.so, libegl.so, libopensl.so and so on.

After querying the file content corresponding to the symbol from the C runtime library, the C runtime library address acquiring module 336 acquires the memory address, of the file content corresponding to the symbol, in the Windows system. The acquiring method is the same as the method for acquiring the memory address, of the file content of the other ELF files, in the Windows system.

Various modules included in the acquiring module 330 may be selected as needed, and this embodiment is not limited to including all the modules.

The linking module 340 is configured to link the symbol with the memory address, of the file content corresponding to the symbol, in the Windows system.

After the acquiring module 330 is executed, the linking module 340 links the symbol with the acquired memory address, of the file content corresponding to the symbol, in the Windows system so that the file content corresponding to the symbol may be executed according to the link when the symbol is invoked or used.

By using the apparatus for loading an ELF file of a Linux system into a Windows system according to the embodiments of the present invention, after the ELF file is resolved, the whole ELF file is loaded into the Windows system memory according to the Windows system memory storage rule. The memory address, of the file content corresponding to a symbol recorded in a symbol table of the ELF file, in the Windows system is acquired in accordance with a resolution result of the ELF file. The symbol is linked with the memory address, of the file content corresponding to the symbol, in the Windows system. In this way, it is implemented that the ELF file is directly loaded into the Windows system memory so that a symbol, such as a function and so on, in the ELF file may directly run on the Windows system without installing the Android virtual machine on the Windows system. Further, loading the file content corresponding to the symbol and acquiring and linking the symbol with the memory address in the Windows system also may be implemented when the ELF files are referenced. Meanwhile, the C runtime library is added to reconstruct a plurality of system functions, and a thread processing function and a signal processing function are added, thereby ensuring proper running of the ELF file on the Windows system, greatly improving the running speed and reducing occupation of hard disk space and a memory.

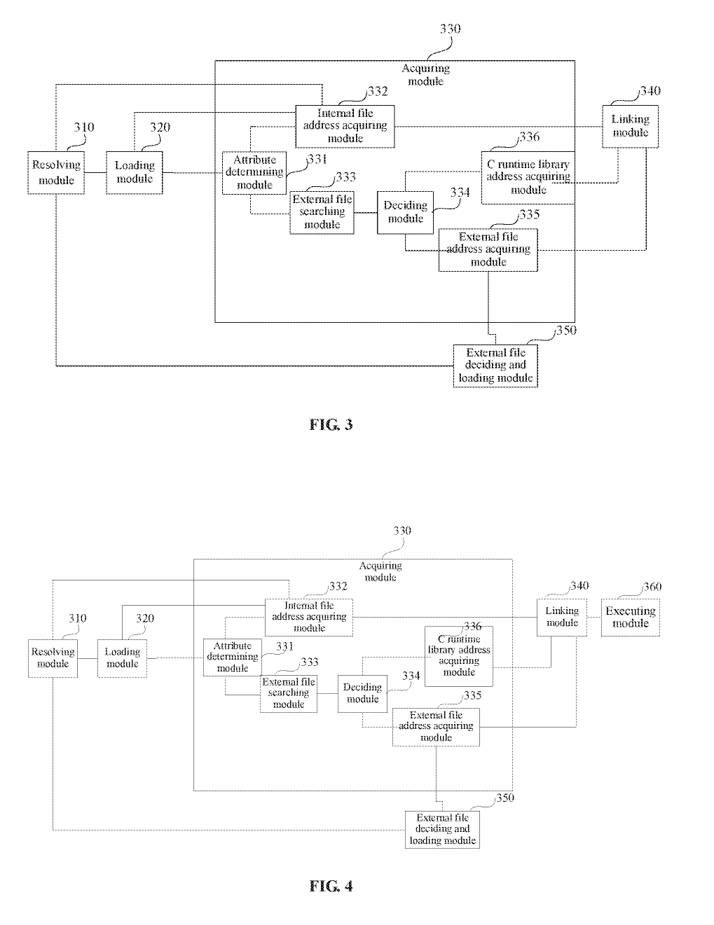

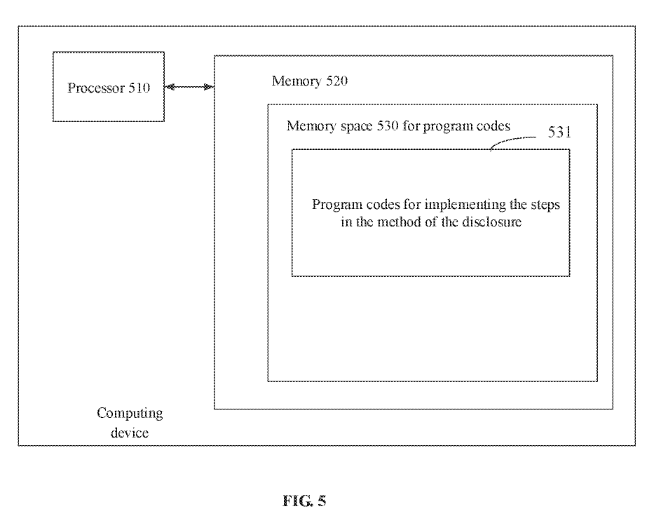

FIG. 4 is a functional block diagram of an apparatus for loading an ELF file of a Linux system into a Windows system according to another embodiment of the present invention. As compared with FIG. 3, the apparatus for loading an ELF file of a Linux system into a Windows system further includes an executing module 360.

The executing module 360 is configured to execute in sequence functions recorded in an initialization array in the ELF file to complete initialization after the linking module 340 links the symbol with the memory address, of the file content corresponding to the symbol, in the Windows system.

The executing module 360 initializes an ELF file whose the ELF file type is an executable object file. During the initialization, the executing module 360 executes in sequence functions recorded in an initialization array (Init and/or PreInit) in the ELF file. The Init is an initialization function that is necessarily executed, and the PreInit is an initialization function that is optionally executed.

By using the apparatus for loading an ELF file of a Linux system into a Windows system according to the embodiments of the present invention, after the ELF file is resolved, the whole ELF file is loaded into the Windows system memory according to the Windows system memory storage rule. The file content corresponding to the symbol is determined to be an internal file content or an external file content in accordance with the attribute of the symbol. The internal file content and the external file content are respectively processed. The memory address, of the file content corresponding to the symbol, in the Windows system is acquired. The symbol is linked with the memory address, of the file content corresponding to the symbol, in the Windows system. The functions recorded in the initialization array in the ELF file are executed in sequence to complete the initialization. In this way, the initialization of the ELF file is also completed in the Windows system, the ELF file is better used, proper running of a Linux file on the Windows system is implemented, installation of the Android virtual machine in the Windows system is avoided, the running speed is greatly improved, and occupation of hard disk space and a memory is reduced.

Algorithm and display provided herein are not inherently related to a particular computer, virtual system or other equipment. Various general systems may also be used with the teaching based on the present invention. According to the above description, the required structure for constructing such a system is obvious. In addition, the present invention is not directed to any particular programming language. It should be understood that a variety of programming languages can be used to implement the disclosed contents as described herein and above description to the particular programming language is to disclose the best inventive implementation mode.

Many details are discussed in the specification provided herein. However, it should be understood that the embodiments of the present invention can be implemented without these specific details. In some examples, the well-known methods, structures and technologies are not shown in detail so as to avoid an unclear understanding of the description.

Similarly, it should be understood that, in order to simplify the present invention and to facilitate the understanding of one or more of various aspects thereof, in the above description of the exemplary embodiments of the present invention, various features of the present invention may sometimes be grouped together into a single embodiment, accompanying figure or description thereof. However, the method of this present invention should not be constructed as follows: the present invention for which the protection is sought claims more features than those explicitly disclosed in each of claims. More specifically, as reflected in the following claims, the inventive aspect is in that the features therein are less than all features of a single embodiment as disclosed above. Therefore, claims following specific embodiments are definitely incorporated into the specific embodiments, wherein each of claims can be considered as a separate embodiment of the present invention.

It should be understood by those skilled in the art that modules of the device in the embodiments can be adaptively modified and arranged in one or more devices different from the embodiment. Modules, units or components in the embodiment can be combined into one module, unit or component, and also can be divided into more sub-modules, sub-units or sub-components. Except that at least some of features and/or processes or units are mutually exclusive, various combinations can be used to combine all the features disclosed in specification (including claims, abstract and accompanying figures) and all the processes or units of any methods or devices as disclosed herein. Unless otherwise definitely stated, each of features disclosed in specification (including claims, abstract and accompanying figures) may be taken place with an alternative feature having same, equivalent or similar purpose.

In addition, it should be understood by those skilled in the art, although some embodiments as discussed herein comprise some features included in other embodiment rather than other feature, combination of features in different embodiment means that the combination is within a scope of the present invention and forms the different embodiment. For example, in the claims, any one of the embodiments for which the protection is sought can be used in any combination manner.

Each of devices according to the embodiments of the present invention can be implemented by hardware, or implemented by software modules operating on one or more processors, or implemented by the combination thereof. A person skilled in the art should understand that, in practice, a microprocessor or a digital signal processor (DSP) may be used to realize some or all of the functions of some or all of the parts in the apparatus for loading an ELF file of a Linux system into a Windows system according to the embodiments of the present invention. The present invention may further be implemented as equipment or device program (for example, computer program and computer program product) for executing some or all of the methods as described herein. Such program for implementing the present invention may be stored in the computer readable medium, or have a form of one or more signals. Such a signal may be downloaded from the Internet websites, or be provided on a carrier signal, or provided in any other form.

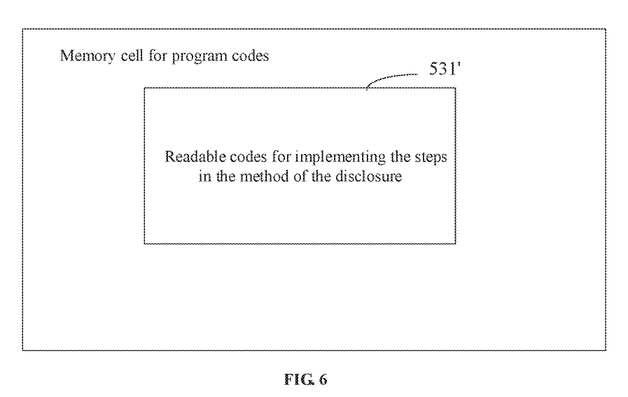

For example, FIG. 5 is a computing device for executing the method for loading an ELF file of a Linux system into a Windows system according to the present invention. Traditionally, the computing device includes a processor 510 and a program product or a readable medium in form of a memory 520. The memory 520 could be electronic memories such as flash memory, EEPROM (Electrically Erasable Programmable Read-Only Memory), EPROM or ROM. The memory 520 has a memory space 530 for executing program codes 531 of any steps in the above methods. For example, the memory space 530 for program codes may include respective program codes 531 for implementing the respective steps in the method as mentioned above. These program codes may be read from and/or be written into one or more program products. These program products include program code carriers such as memory card. These program products are usually the portable or stable memory cells as shown in FIG. 6. The memory cells may be provided with memory sections, memory spaces, etc., similar to the memory 520 of the computing device as shown in FIG. 5. The program codes may be compressed for example in an appropriate form. Usually, the memory cell includes readable codes 531′ which can be read for example by processors 510. When these codes are operated on the computing device, the computing device may execute respective steps in the method as described above.

It should be noted that the above-described embodiments are intended to illustrate but not to limit the present invention, and alternative embodiments can be devised by a person skilled in the art without departing from the scope of claims as appended. In the claims, no reference mark between round brackets shall impose restriction on the claims. The word “include/comprise” does not exclude a component or step not listed in the claims. The wording “a” or “an” in front of an element does not exclude the presence of a plurality of such elements. The present invention may be realized by means of hardware comprising a number of different elements and by means of a suitably programmed computer. In the unit claim listing a plurality of devices, some of these devices may be embodied in the same hardware. The wordings “first”, “second”, and “third”, etc. do not denote any order. These wordings can be construed as naming.

1. A method for loading an ELF file of a Linux system into a Windows system, comprising:
resolving the ELF file in accordance with a format of the ELF file;
loading the whole ELF file into a Windows system memory according to a Windows system memory storage rule;
acquiring a memory address, of a file content corresponding to a symbol recorded in a symbol table of the ELF file, in the Windows system in accordance with a resolution result of the ELF file; and
linking the symbol with the memory address, of the file content corresponding to the symbol, in the Windows system.

2. (canceled)

3. The method according to claim 1, wherein after linking the symbol with the memory address, of the file content corresponding to the symbol, in the Windows system, the method further comprises: executing in sequence functions recorded in an initialization array in the ELF file to complete initialization.

4. The method according to claim 1, wherein the resolving the ELF file in accordance with a format of the ELF file further comprises:
resolving a content of an ELF header of the ELF file, wherein the content of the ELF header comprises a type of the ELF file, a starting address of the ELF file, and an offset address of the file content.

5. The method according to claim 1, wherein the loading the whole ELF file into a Windows system memory according to a Windows system memory storage rule further comprises:
performing cross-page processing and storing remaining ELF files according to a Windows system memory page management rule when current page space in the Windows system memory is insufficient.

6. The method according to claim 1, wherein the loading the whole ELF file into a Windows system memory according to a Windows system memory storage rule further comprises:
performing alignment processing and storing remaining ELF files according to a Windows system memory alignment rule when continuing storing the ELF file is unavailable because current byte space in the Windows system memory is insufficient.

7. The method according to claim 1, wherein before acquiring a memory address, of a file content corresponding to a symbol recorded in a symbol table of the ELF file, in the Windows system, the method further comprises:
acquiring an attribute of the symbol recorded in the symbol table; and
determining the file content corresponding to the symbol to be an internal file content or an external file content in accordance with the attribute of the symbol.

8. The method according to claim 7, wherein the acquiring a memory address, of a file content corresponding to a symbol recorded in a symbol table of the ELF file, in the Windows system in accordance with a resolution result of the ELF file further comprises:
acquiring the memory address, of the file content corresponding to the symbol, in the Windows system by calculating according to the starting address of the ELF file and the offset address of the file content obtained by resolution when the file content corresponding to the symbol is the internal file content.

9. The method according to claim 7, wherein the acquiring a memory address, of a file content corresponding to a symbol recorded in a symbol table of the ELF file, in the Windows system in accordance with a resolution result of the ELF file further comprises:
searching other ELF files referenced by the ELF file from the ELF file when the file content corresponding to the symbol is the external file content;
deciding whether the file content corresponding to the symbol is a file content of the other ELF files; and
acquiring a memory address, of the file content of the other ELF files, in the Windows system when the decision result is yes.

10. The method according to claim 9, further comprising:
loading the other ELF files when the file content corresponding to the symbol is decided as the file content of the other ELF files but the other ELF files are not loaded into the Windows system memory.

11. The method according to claim 7, wherein the acquiring a memory address, of a file content corresponding to a symbol recorded in a symbol table of the ELF file, in the Windows system in accordance with a resolution result of the ELF file further comprises:
querying the file content corresponding to the symbol from a C runtime library when the file content corresponding to the symbol is the external file content, and acquiring the memory address, of the file content corresponding to the symbol, in the Windows system when the file content is queried out.

12. (canceled)

13. A computing device for loading an ELF file of a Linux system into a Windows system, comprising:
a memory having instructions stored thereon;
a processor configured to execute the instructions to perform operations for loading an ELF file of a Linux system into a Windows system, the operations comprising:
resolving the ELF file in accordance with a format of the ELF file;
loading the whole ELF file into a Windows system memory according to a Windows system memory storage rule;
acquiring a memory address, of a file content corresponding to a symbol recorded in a symbol table of the ELF file, in the Windows system in accordance with a resolution result of the ELF file; and
linking the symbol with the memory address, of the file content corresponding to the symbol, in the Windows system.

14. (canceled)

15. The computing device according to claim 13, wherein the operations further comprise:
executing in sequence functions recorded in an initialization array in the ELF file to complete initialization after linking the symbol with the memory address, of the file content corresponding to the symbol, in the Windows system.

16. The computing device according to claim 13, wherein the operation of resolving the ELF file in accordance with a format of the ELF file further comprises: resolving a content of an ELF header of the ELF file, wherein the content of the ELF header comprises a type of the ELF file, a starting address of the ELF file, and an offset address of the file content.

17. The computing device according to claim 13, wherein the operation of loading the whole ELF file into a Windows system memory according to a Windows system memory storage rule further comprises:
performing cross-page processing and store remaining ELF files according to a Windows system memory page management rule when current page space in the Windows system memory is insufficient.

18. The computing device according to claim 13, wherein the operation of loading the whole ELF file into a Windows system memory according to a Windows system memory storage rule further comprises:
performing alignment processing and storing remaining ELF files according to a Windows system memory alignment rule when continuing storing the ELF file is unavailable because current byte space in the Windows system memory is insufficient.

19. The computing device according to claim 13, wherein before acquiring a memory address, of a file content corresponding to a symbol recorded in a symbol table of the ELF file, in the Windows system, the operation further comprises:
acquiring an attribute of the symbol recorded in the symbol table and determining the file content corresponding to the symbol to be an internal file content or an external file content in accordance with the attribute of the symbol.

20. The computing device according to claim 19, wherein the operation of acquiring a memory address, of a file content corresponding to a symbol recorded in a symbol table of the ELF file, in the Windows system in accordance with a resolution result of the ELF file further comprises:
acquiring the memory address, of the file content corresponding to the symbol, in the Windows system by calculating according to the starting address of the ELF file and the offset address of the file content obtained by resolution when the file content corresponding to the symbol is the internal file content.

21. The computing device according to claim 19, wherein the operation of acquiring a memory address, of a file content corresponding to a symbol recorded in a symbol table of the ELF file, in the Windows system in accordance with a resolution result of the ELF file further comprises:
searching other ELF files referenced by the ELF file from the ELF file when the file content corresponding to the symbol is the external file content;
deciding whether the file content corresponding to the symbol is a file content of the other ELF files; and
acquiring a memory address, of the file content of the other ELF files, in the Windows system.

22. The computing device according to claim 21, wherein the operations further comprise:
deciding whether the other ELF files have been loaded into the Windows system memory when the file content corresponding to the symbol is decided as the file content of the other ELF files, and loading the other ELF files when they are not loaded yet.

23. The computing device according to claim 19, wherein the operation of acquiring a memory address, of a file content corresponding to a symbol recorded in a symbol table of the ELF file, in the Windows system in accordance with a resolution result of the ELF file further comprises:
querying the file content corresponding to the symbol from a C runtime library when the file content corresponding to the symbol is the external file content, and acquiring the memory address, of the file content corresponding to the symbol, in the Windows system when the file content is queried out.

24.-25. (canceled)

26. A non-transitory computer-computer-readable medium having computer programs stored thereon that, when executed by one or more processors of a computing device, cause the computing device to perform operations for loading an ELF file of a Linux system into a Windows system, comprising:
resolving the ELF file in accordance with a format of the ELF file;
loading the whole ELF file into a Windows system memory according to a Windows system memory storage rule;
acquiring a memory address, of a file content corresponding to a symbol recorded in a symbol table of the ELF file, in the Windows system in accordance with a resolution result of the ELF file; and
linking the symbol with the memory address, of the file content corresponding to the symbol, in the Windows system.
